(19) United States
(12) Patent Application Publication
(10) Pub. No.: US 2006/0043878 A1
(43) Pub. Date: Mar. 2, 2006

(54) Image display unit

(75) Inventors: Masayuki Yoshii, Fukaya-shi (JP); Takeo Ito, Kumagaya-shi (JP); Hajime Tanaka, Fujioka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/519,849

(22) PCT Filed: Jul. 10, 2003
(86) PCT No.: PCT/JP03/08743

§ 371 Date: Jul. 29, 2005

(30) Foreign Application Priority Data
Jul. 15, 2002 (JP) 2002-205818

(51) Int. Cl. H01J 63/04; H01J 1/62

(52) U.S. Cl. 313/497; 313/496; 313/495

(57) ABSTRACT

An image display unit comprising a high-resistance gap section disposed between a grounding section and the outer peripheral edge of a metal back layer so as to surround the outer peripheral edge, the high-resistance gap section having a surface roughness of 1.0 to 15.0 μm. The high-resistance gap section can have a high-resistance coating layer with a surface resistivity of 1×10⁹ to 1×10¹⁵ Ω/□. The high-resistance gap section can be formed of plural regions so disposed that their surface roughness or surface resistivity sequentially increases from the inner side toward the outer side. Accordingly, surface discharge from the outer peripheral edge of a metal back layer is restricted to prevent the destruction or deterioration of an electron emission element and a fluorescent surface.

### TECHNICAL FIELD

The present invention relates to an image display unit, and more particularly an image display unit which is retarded from creeping discharges at the outer peripheral edge section of a metal back layer and has an outstanding withstand voltage characteristic.

### BACKGROUND ART

In recent years, flat-panel image display units comprising plural field emission type electron emission elements have been developed as next-generation image display units, which are called field emission displays (hereinafter referred to as the FEDs). Among the FEDs, a display unit comprising surface conduction type electron emission elements is also called a surface conduction type electron-emitting display (SED). But the term FED is used in the present invention as a general term also including the SED.

Generally, the FED has a structure in that a front substrate (face plate) comprising a fluorescent surface and a rear substrate (rear plate) having electron emission elements are opposed to each other and spaced apart with a prescribed gap between them. The front substrate and the rear substrate are joined together at their peripheral edges with a rectangular frame-shaped side wall interposed between them to constitute a vacuum envelope. The interior of the vacuum envelope is maintained at a high vacuum degree lower than 10⁻⁴ Pa. Plural support members are arranged between the front substrate and the rear substrate to support a load due to the atmospheric pressure applied to the substrates.

The fluorescent surface of the front substrate has a structure in that three color phosphor layers of red (R), green (G) and blue (B) and a light-absorbing layer respectively formed on the inner surface of a glass substrate and a metal back layer such as an aluminum film formed thereon. Then, an anode voltage is applied to the metal back layer of the fluorescent surface. The electrons emitted from the electron emission elements are accelerated by the anode voltage. A beam of the accelerated electrons impinges on the fluorescent surface to excite the individual color phosphors so as to emit light. Thus, images are displayed.

The FED configured as described above can be designed to have a gap of several millimeters or less between the front substrate and the rear substrate, so that it can be made large, thin and lightweight in comparison with an image display unit of a cathode ray tube (CRT) type.

The FED, however, had the very small gap between the front substrate and the rear substrate into which a high voltage of about 10 kV was applied to form an intense electric field, so that it had a disadvantage that discharge (vacuum arc discharge) was apt to occur when images were formed for a long period of time.

The front substrate has a gap of about 5 mm in width between the metal back layer, to which a high voltage is applied, and an outer grounding portion to save space, and the glass substrate of this portion functions as a high-resistance gap portion. An intense electric field is also developed in this high-resistance gap section, and there is a possibility for discharge to occur.

If an abnormal discharge occurs, a large discharge current in a range of several to several hundred amperes flows instantaneously, resulting in a possibility of destructing or damaging the electron emission elements of a cathode section or the fluorescent surface of an anode section.

Meanwhile, measures for suppressing a scale of discharge are being studied in order to prevent an effect upon the electron emission elements and the like even if the discharge occurs. For example, there is disclosed a technology that a notch is formed in the metal back layer which is disposed on the fluorescent surface to enhance the inductance and resistance of the fluorescent surface (Japanese Patent Laid-Open Application No. 2000-311642).

But, the above method had substantially no effect of suppressing the discharge from the outer peripheral edge portion of the metal back layer.

The present invention has been made to remedy the above disadvantages and provides an image display unit that prevents destruction or deterioration of the electron emission elements and the fluorescent surface by suppressing a discharge from the outer peripheral edge of the metal back layer, thereby enabling to make a high-brightness and high-dignity display.

### SUMMARY OF THE INVENTION

According to a first aspect of the present invention, there is provided an image display unit comprising a cathode substrate having an electron source for emitting electrons and an anode substrate disposed to oppose the cathode substrate. And, the anode substrate has a transparent substrate, a grounding section formed on the peripheral edge of the transparent substrate, a phosphor layer which is formed on the inner surface of the transparent substrate and excited by electrons emitted from the electron source to emit light, a metal back layer to which a high voltage is applied to accelerate the electrons, and a high-resistance section which is disposed between the metal back layer and the grounding section to surround the outer peripheral edge of the metal back layer; and the high-resistance section has a surface roughness of 1.0 to 15.0 μm.

According to a second aspect of the present invention, there is provided an image display unit comprising a cathode substrate having an electron source for emitting electrons and an anode substrate disposed to oppose the cathode substrate. The anode substrate has a transparent substrate, a grounding section formed on the peripheral edge of the transparent substrate, a phosphor layer which is formed on the inner surface of the transparent substrate and excited by electrons emitted from the electron source to emit light, a metal back layer to which a high voltage is applied to accelerate the electrons, and a high-resistance section which is disposed between the metal back layer and the grounding section to surround the outer peripheral edge of the metal back layer; and the high-resistance section has a high-resistance coating layer with a surface resistivity of 1×10⁹ to 1×10¹⁵ Ω/□ (square; the same is applied below).

### BRIEF DESCRIPTION OF THE DRAWINGS

FIG. 1 is a sectional view showing a first embodiment of applying an image display unit of the present invention to FED.

FIG. 2 is a plan view showing a structure of the inner surface of a front substrate according to the first embodiment.

FIG. 3 is a plan view showing an enlarged image of the structure of the inner surface of the front substrate according to a second embodiment of the present invention.

FIG. 4 is a plan view showing an enlarged image of the structure of the inner surface of the front substrate according to a third embodiment of the present invention.

FIG. 5 is a plan view showing an enlarged image of the structure of the inner surface of the front substrate according to a fourth embodiment of the present invention.

FIG. 6 is a plan view showing an enlarged image of the structure of the inner surface of the front substrate according to a fifth embodiment of the present invention.

### BEST MODE FOR CARRYING OUT THE INVENTION

Embodiments of applying the display unit of the invention to the FED will be described with reference to the drawings. It is to be understood that the present invention is not limited to the following embodiments.

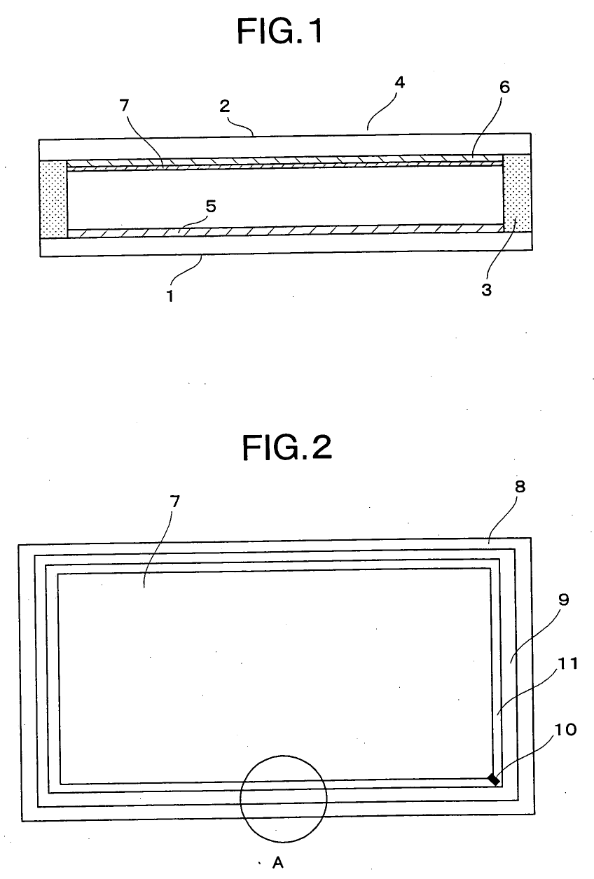

This FED has a rear substrate (rear plate) 1 and a front substrate (face plate) 2 each having a rectangular glass substrate as shown in FIG. 1. These substrates are disposed to oppose each other with a prescribed gap (e.g., 2 mm) between them and are joined together at their peripheral edges with a rectangular frame-shaped side wall (support frame) 3 of glass interposed between them to constitute a vacuum envelope 4. And, plural spacers (not shown) are arranged with prescribed intervals within the vacuum envelope 4 to maintain the gap between the substrates. The spacers are formed to have a shape of a plate or a column.

The inner surface of the rear substrate 1 comprises an electron generating source 5 which is formed to have a large number of surface conduction type electron emission elements for emitting electron beams for exciting phosphors.

A phosphor screen 6 is formed on the inner surface of the front substrate 2. The phosphor screen 6 has a light-absorbing layer, which is formed of stripes or dots of a black pigment (e.g., graphite) and three color phosphor layers of red (R), blue (B) and green (G), and a metal back layer 7 of an aluminum film or the like on the phosphor layer.

As shown in FIG. 2, the front substrate 2 has a high-resistance gap section 9 with a width of about 5 mm between the outer peripheral edge of the metal back layer 7 and an outer grounding section 8. According to the first embodiment, the surface (the inner surface) of the glass substrate has a surface roughness (average surface roughness Ra) of 1.0 to 15.0 μm in the high-resistance gap section 9. The surface roughness is formed by applying a surface roughening treatment such as a sand blast to the surface of the glass substrate.

In the drawing, reference numeral 10 indicates a section for supplying an anode voltage to the metal back layer 7, and reference numeral 11 indicates a conductive layer having a function as an electrode. The conductive layer 11 can be the same as the light-absorbing layer formed of graphite.

The surface roughness of the high-resistance gap section 9 is limited to the above-described range because of the following reasons. Specifically, if the surface roughness of the high-resistance gap section 9 is less than 1.0 μm, the extension of a creeping distance has substantially no effect of suppressing a discharge, and if the surface roughness conversely exceeds 15.0 am, the front substrate 2 (glass substrate) has an inadequate thermal stress and bending stress, resulting in a reduced yield.

According to the first embodiment configured as described above, the surface of the glass substrate is undergone the surface roughening treatment, so that the high-resistance gap section 9 has a surface roughness of 1.0 to 15.0 am, and a distance (creeping distance) along the plane from the outer peripheral edge of the metal back layer 7 to the grounding section 8 becomes long in comparison with a conventional image display unit having a smooth-surfaced high-resistance gap section. As a result, a creeping discharge from the outer peripheral edge of the metal back layer is suppressed, and a withstand voltage characteristic is improved. Therefore, the electron emission elements and the fluorescent surface are prevented from destruction, damage or deterioration, and good display characteristics stable for a long period can be obtained.

Then, second to sixth embodiments of the present invention will be described.

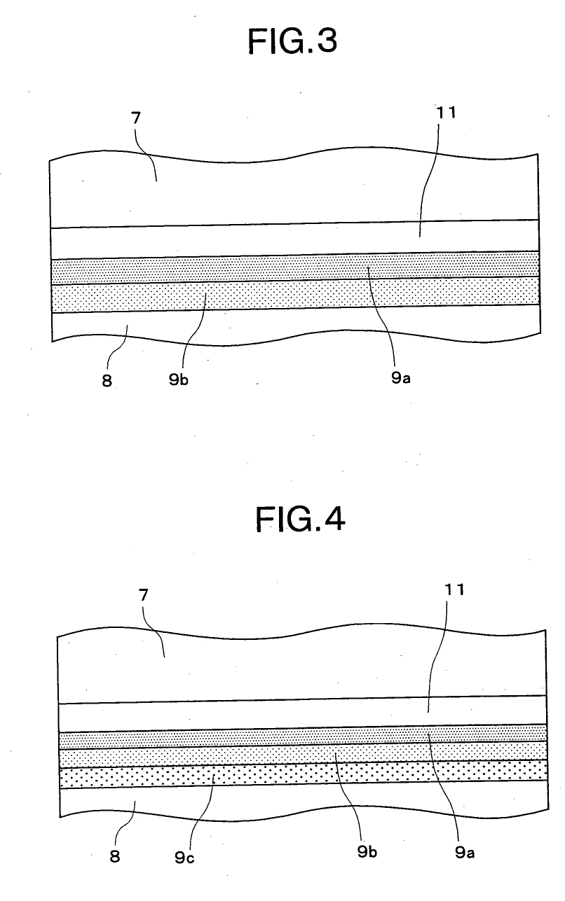

FIG. 3 is a plan view showing an enlarged image of the main portion (a high-resistance gap section and its vicinity, corresponding to portion A in FIG. 2) of the second embodiment, and FIG. 4 is a plan view showing an enlarged 15′ view of the main portion of the third embodiment.

As shown in FIG. 3 and FIG. 4, the high-resistance gap section 9 according to the second and third embodiments has plural regions 9a, 9b, 9c, . . . (two regions in FIG. 3, and three regions in FIG. 4) which are similarly disposed to surround the metal back layer 7, and the individual regions have a surface roughness of 1.0 to 15.0 μm. These regions are determined to be a first region 9a, a second region 9b, a third region 9c, . . . from the side closer to the outer peripheral edge of the metal back layer toward the side away from it, and when the surface roughnesses of the regions are assumed to be R1, R2, R3, . . . , they are in relationship of R1<R2<R3 . . . . In the second and third embodiments, the other portions are configured in the same manner as in the first embodiment, so that the description is omitted.

According to the second and third embodiments configured as described above, a discharge (creeping discharge) along the plane from the outer peripheral edge of the metal back layer 7 is more effectively suppressed than in the first embodiment, and a withstand voltage characteristic is improved.

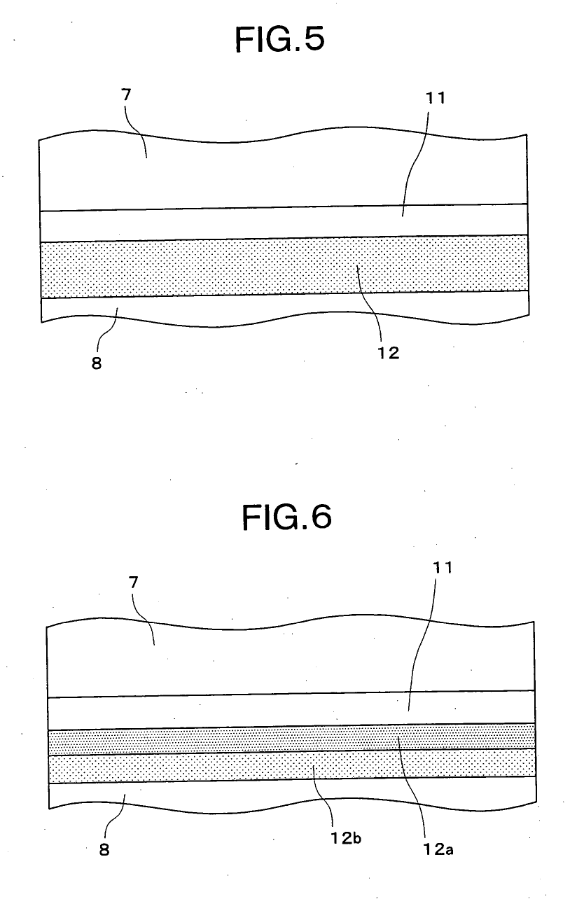

FIG. 5 is a plan view showing an enlarged image of the main portion of the fourth embodiment. In this embodiment, the high-resistance gap section 9 between the outer peripheral edge of the metal back layer 7 and the grounding section 8 has a high-resistance layer 12 with a surface resistivity of 1×10⁹ to 1×10¹⁵ Ω/□ in the inner surface of the glass substrate. The other portions are configured in the same manner as in the first embodiment, and the description is omitted.

Here, as the high-resistance layer 12 having a surface resistivity of 1×10⁹ to 1×10¹⁵ Ω/□, a layer of an oxide such as at least one type of metal selected from Al, In, Sn, Bi, Si and Sb can be used. A layer of metal nitride such as AlN can also be used. It is desirable that the high-resistance layer 12 has a thickness of 200 to 500 nm.

To form an oxide layer of metal such as Al, In, Sn, Bi or Sb as the high-resistance layer 12, for example, the following method can be adopted. Specifically, the metal such as Al, In, Sn, Bi or Sb is deposited at a high vacuum degree of 5×10⁻⁵ to 3×10⁻⁴ Torr (6.7×0⁻³ to 4.0×10⁻² Pa) while introducing oxygen at a ratio of 0.5 to 4 L/minute under plasma discharge. Thus, the introduced oxygen is actively ionized, and a deposit can be continuously oxidized by the actively ionized oxygen to form the above-described metal oxide layer. And, the value of surface resistivity of the metal oxide layer to be formed can be controlled by adjusting the oxygen introducing amount.

As the evaporation method, a high-frequency induction heating deposition method, an electric resistance heating deposition method, an electron beam heating deposition method, a sputtering deposition method or an ion plating deposition method can be applied.

A method such as sputtering can be adopted to form a layer of an Si oxide or AlN.

According to the fourth embodiment configured as described above, the high-resistance gap section 9 disposed between the outer peripheral edge of the metal back layer 7 and the grounding section 8 has the high-resistance layer 12 with a high surface resistivity of 1×10⁹ to 1×10¹⁵ Ω/□. Thus, a creeping discharge from the outer peripheral edge of the metal back layer 7 is suppressed, and the withstand voltage characteristic is improved. Therefore, the electron emission elements and the fluorescent surface are prevented from having destruction, damage or deterioration, and an image display unit having stable and good display characteristics can be obtained.

FIG. 6 is a plan view showing an enlarged image of the main portion of the fifth embodiment. According to the fifth embodiment, the high-resistance gap section 9 has plural regions (two regions in FIG. 6) which are similarly disposed to surround the metal back layer 7, and the individual regions have high-resistance layers 12a, 12b with a high surface resistivity of 1×10⁹ to 1×10¹⁵ Ω/□. These regions are assumed to be a first region, a second region, . . . from the side closer to the outer peripheral edge of the metal back layer 7 toward the side away from it, and when it is assumed that the surface resistivity of the high-resistance layer 12a of the first region is r1, the surface resistivity of the high-resistance layer 12b of the second region is r2, . . . , they are in relationship of r1<r2 . . . .

According to the fifth embodiment configured as described above, a creeping discharge from the outer peripheral edge of the metal back layer 7 is more effectively suppressed than in the fourth embodiment, and a withstand voltage characteristic is improved.

Besides, according to the sixth embodiment, the high-resistance gap section between the outer peripheral edge of the metal back layer and the grounding section is configured as described below. Specifically, the glass substrate of the high-resistance gap section has a surface roughness of 1.0 to 15.0 μm by applying a surface roughening treatment such as a sand blast, and a high-resistance layer having a surface resistivity of 1×10⁹ to 1×10¹⁵ Ω/□ is formed on it. The high-resistance layer can be formed in the same manner as in the fifth embodiment.

According to the sixth embodiment configured as described above, a creeping discharge from the outer peripheral edge of the metal back layer is more effectively suppressed than in the above-described first to fifth embodiments, and the display unit has a quite outstanding withstand voltage characteristic.

Then, specific examples will be described.

### EXAMPLE 1

In a high-resistance gap section between the outer peripheral edge of a portion, where an Al film (a metal back layer) was to be formed, and an outer grounding section, the surface of a glass substrate was previously subjected to a sand blast to have surface roughness (average surface roughness Ra) of 6 μm.

A light-absorbing layer in stripes of a black pigment was formed on the glass substrate by a photolithography method, and three color stripe phosphor layers of red (R), green (G) and blue (B) were formed to be adjacent to each other between light-shielding sections. The individual color phosphor layers were patterned by the photolithography method. Thus, a fluorescent surface was formed.

Then, the metal back layer was formed on the fluorescent surface. Specifically, an organic resin solution mainly including acrylic resin was applied onto the fluorescent surface and dried to form an organic resin layer. An Al film (thickness of 100 nm) was formed on it by vacuum deposition and heated for calcination at a temperature of 450° C. for 30 minutes to decompose an organic content for its removal.

The glass substrate having the fluorescent surface on which the metal back layer was formed was used as a face plate to produce FED by an ordinary method. First, an electron generating source having a large number of surface conduction type electron emission elements formed in matrix on a substrate was fixed to the glass substrate to produce a rear plate. Then, the rear plate and the face plate were disposed to face each other with a support frame and a spacer between them and sealed by flit glass. The face plate and the rear plate had a gap of 2 mm between them. Then, necessary treatments such as vacuum discharge, sealing and the like were performed to complete the FED.

The obtained FED was measured for a withstand voltage characteristic. To measure the withstand voltage characteristic, a voltage was applied between the metal back layer and the grounding section, and a maximum voltage was measured until a creeping discharge occurred from the outer peripheral edge of the metal back layer to the grounding section. The maximum voltage value was determined as a creepage surface withstand voltage.

The creepage surface withstand voltage value was 8.0 kV in Example 1. It was found that the withstand voltage characteristic was improved considerably in Example 1 because the FED having a conventional structure with the glass substrate not undergone the surface roughening treatment had a creepage surface withstand voltage value of 4.0 kV.

### EXAMPLE 2

After an Al film was formed on a fluorescent surface, a high-resistance layer of an Al oxide having a surface resistivity of 5×10¹² Ω/□ was formed on the surface of a glass substrate in a high-resistance gap section between the outer peripheral edge of the Al film (a metal back layer) and a grounding section. The high-resistance layer was formed by depositing aluminum at a high vacuum degree while inducing oxygen under plasma discharge.

Then, the glass substrate having the metal-backed fluorescent surface was used as a face plate to produce the FED in the same way as in Example 1.

The obtained FED was measured for a withstand voltage characteristic in the same way as in Example 1, and a maximum voltage (creepage surface withstand voltage) value which did not lead to a discharge was 11 kv. It was found that the withstand voltage characteristic was improved furthermore than in Example 1.

### EXAMPLE 3

Before forming an Al film on a fluorescent surface, the surface of a glass substrate was subjected to a sand blast to have average surface roughness Ra of 6 μm in a high-resistance gap section between the outer peripheral edge of a portion, where the Al film (a metal back layer) was to be formed, and an outer grounding section in the same way as in Example 1. Then, after the Al film was formed on the fluorescent surface, a high-resistance layer of an Al oxide having a surface resistivity of 5×10¹² Ω/□ was formed on the glass substrate which had its surface roughened to the surface roughness Ra of 6 μm. The high-resistance layer was formed by depositing aluminum at a high vacuum degree while inducing oxygen under plasma discharge.

Then, the glass substrate having the metal-backed fluorescent surface was used as a face plate to produce the FED in the same way as in Example 1.

The obtained FED was measured for a withstand voltage characteristic in the same way as in Example 1. It was found that a maximum voltage (creepage surface withstand voltage) value which did not lead to a discharge, was 16 kV, and the FED was improved considerably than in Example 1 and Example 2 and had a quite outstanding withstand voltage characteristic.

### INDUSTRIAL APPLICABILITY

As described above, a creeping discharge from the outer peripheral edge of the metal back layer is suppressed on the front substrate according to the present invention, so that destruction or deterioration of the electron emission elements and the fluorescent surface is prevented, and the image display unit capable of making high-brightness and high-dignity display can be obtained.

What is claimed is:

1. An image display unit comprising a cathode substrate with an electron source for emitting electrons and an anode substrate disposed to oppose the cathode substrate,
wherein the anode substrate has a transparent substrate, a grounding section formed on the peripheral edge of the transparent substrate, a phosphor layer which is formed on the inner surface of the transparent substrate and excited by electrons emitted from the electron source to emit light, a metal back layer to which a high voltage is applied to accelerate the electrons, and a high-resistance section which is disposed between the metal back layer and the grounding section to surround the outer peripheral edge of the metal back layer; and
wherein the high-resistance section has a surface roughness of 1.0 to 15.0 μm.

2. The image display unit according to claim 1,
wherein the high-resistance section comprises plural regions with a surface roughness of 1.0 to 15.0 μm, and these regions are disposed to increase their surface roughness sequentially from the side closer to the outer peripheral edge of the metal back layer toward the side away from it.

3. An image display unit comprising a cathode substrate with an electron source for emitting electrons and an anode substrate disposed to oppose the cathode substrate,
wherein the anode substrate has a transparent substrate, a grounding section formed on the peripheral edge of the transparent substrate, a phosphor layer which is formed on the inner surface of the transparent substrate and excited by electrons emitted from the electron source to emit light, a metal back layer to which a high voltage is applied to accelerate the electrons, and a high-resistance section which is disposed between the metal back layer and the grounding section to surround the outer peripheral edge of the metal back layer; and
wherein the high-resistance section has a high-resistance coating layer with a surface resistivity of 1×10⁹ to 1×10¹⁵ Ω/□ (square; the same is applied below).

4. The image display unit according to claim 3,
wherein the high-resistance section has a rough surface section with a surface roughness of 1.0 to 15.0 μm, and the high-resistance coating layer is formed on the rough surface section.

5. The image display unit according to claim 3 or claim 4, wherein the high-resistance section comprises plural regions having a high-resistance coating layer with a surface resistivity of 1×10⁹ to 1×10¹⁵ Ω/□, and these regions are disposed to increases their surface resistivity sequentially from the side closer to the outer peripheral edge of the metal back layer toward the side away from it.
